(19) United States
(12) Patent Application Publication
(10) Pub. No.: US 2025/0115101 A1
(43) Pub. Date: Apr. 10, 2025

(54) Glass diaphragm, exciter-attached glass diaphragm, method for producing glass diaphragm, and method for producing exciter-attached glass diaphragm

(71) Applicant: AGC Inc., Tokyo (JP)

(72) Inventors: Kento SAKURAI, Tokyo (JP); Jun AKIYAMA, Tokyo (JP)

(73) Assignee: AGC Inc., Tokyo (JP)

(21) Appl. No.: 18/950,514

(22) Filed: Nov. 18, 2024

Related U.S. Application Data
(63) Continuation of application No. PCT/JP2023/018502, filed on May 17, 2023.

(30) Foreign Application Priority Data
May 19, 2022 (JP) 2022-082515

(51) Int. Cl. B60J 1/20; B60R 11/00; B60R 11/02; H04R 1/02

(52) U.S. Cl. CPC B60J 1/2097; B60R 11/0217; H04R 1/028; B60R 2011/0063; H04R 2499/13

(57) ABSTRACT

A glass diaphragm includes: a glass plate structure; a mounting member fixed to the glass plate structure; a connection member that is attached to the mounting member and is to be fixed to an exciter for vibrating the glass plate structure; and a first adhesive layer and a second adhesive layer, each of the first adhesive layer and the second adhesive layer being disposed between the glass plate structure and the mounting member, in which a material of the first adhesive layer is different from a material of the second adhesive layer.

### TECHNICAL FIELD

The present invention relates to a glass diaphragm, an exciter-attached glass diaphragm, a method for producing a glass diaphragm, and a method for producing an exciter-attached glass diaphragm.

### BACKGROUND ART

In recent years, a technique has been studied in which various plate-shaped members, for example, an electronic device member, a vehicular window member, and an interior member of a transport machine such as a vehicle, are vibrated to function as a speaker. For example, Patent Literatures 1 to 5 disclose various structures that transmit vibration of an electrically vibrating exciter (exciter) to a diaphragm such as a glass plate.

Patent Literature 1 discloses a structure in which a sole, a base, and an attachment are laminated in order on a main surface of a glass plate, the sole and the base are fixed with a plastic portion that covers a portion of the glass plate, and an exciter is connected to the attachment on the fixed base.

### CITATION LIST

### Patent Literature

Patent Literature 1: WO2021/229179
Patent Literature 2: WO2021/229180
Patent Literature 3: WO2019/172076
Patent Literature 4: JP2010-263512A
Patent Literature 5: JP2009-100223A

### SUMMARY OF INVENTION

### Technical Problem

However, with such an attachment structure for attaching the exciter to the glass plate, continued use of the vibrating exciter may cause an attachment position to displace, resulting in a decrease in sound reproduction quality or the exciter itself falling off. In addition, in a structure in which the sole and the base are fixed to the glass plate by the plastic portion, such as the attachment structure described in Patent Literature 1, there are problems such as a complicated configuration or difficulty in stably overcoating the plastic portion on the sole and the base.

Therefore, an object of the present invention is to provide a glass diaphragm, an exciter-attached glass diaphragm, a method for producing a glass diaphragm, and a method for producing an exciter-attached glass diaphragm in which an exciter can be stably attached to a glass plate structure, and a decrease in quality of sound emitted from the glass diaphragm and falling off of the exciter due to displacement of the exciter can be prevented.

### Solution to Problem

The present invention has the following configurations.
(1) A glass diaphragm including:
   a glass plate structure;
   a mounting member fixed to the glass plate structure;
   a connection member that is attached to the mounting member and is to be fixed to an exciter for vibrating the glass plate structure; and
   a first adhesive layer and a second adhesive layer, each of the first adhesive layer and the second adhesive layer being disposed between the glass plate structure and the mounting member, in which
   a material of the first adhesive layer is different from a material of the second adhesive layer.
(2) An exciter-attached glass diaphragm including: the glass diaphragm according to the above (1); and the exciter.
(3) A method for producing a glass diaphragm, including:
   in a mounting member that is fixed to a glass plate structure and to which a connection member of an exciter for vibrating the glass plate structure is to be attached, disposing a first adhesive layer on a surface facing the glass plate structure;
   adhering the glass plate structure to the mounting member via the first adhesive layer; and
   injecting an adhesive to be a second adhesive layer through an inlet connected to a space provided inside the mounting member, to adhere the glass plate structure to the mounting member via the second adhesive layer.
(4) A method for producing an exciter-attached glass diaphragm, including:
   performing the method for producing a glass diaphragm according to the above (1); and then
   attaching the exciter to the mounting member.

### Advantageous Effects of Invention

According to the present invention, the exciter can be stably attached to the glass plate structure, and a decrease in quality of sound emitted from the glass diaphragm and falling off of the exciter due to displacement of the exciter can be prevented.

### BRIEF DESCRIPTION OF DRAWINGS

FIG. 1 is a schematic plan view of a glass diaphragm.

FIG. 2 is a schematic cross-sectional view of the glass diaphragm taken along a line II-II in FIG. 1.

FIG. 3 is a perspective view of a mounting member and an exciter fixed to a glass plate structure.

FIG. 4A is a plan view of the mounting member on a side opposite to a side fixed to the glass plate structure.

FIG. 4B is a cross-sectional view of the mounting member in a thickness direction.

FIG. 4C is a plan view of the mounting member on the side fixed to the glass plate structure.

FIG. 5 is a schematic cross-sectional view taken along a line V-V in FIG. 2.

FIG. 6 is a schematic cross-sectional view of a glass diaphragm including a mounting member having through holes in a side wall surface.

FIG. 7A is a diagram illustrating a preparation step in a method for producing a glass diaphragm.

FIG. 7B is a diagram illustrating a first adhesion step in the method for producing a glass diaphragm.

FIG. 7C is a diagram illustrating a second adhesion step in the method for producing a glass diaphragm.

FIG. 7D is a diagram illustrating the second adhesion step in the method for producing a glass diaphragm.

FIG. 7E is a diagram illustrating the second adhesion step in the method for producing a glass diaphragm.

FIG. 8A is a schematic cross-sectional view of a glass diaphragm including a mounting member having one through hole.

FIG. 8B is a schematic cross-sectional view of a glass diaphragm including a mounting member having a plurality of attachment holes.

FIG. 9 is a schematic cross-sectional view of a glass diaphragm according to a first modification.

FIG. 10 is a schematic cross-sectional view of a glass diaphragm according to a second modification.

FIG. 11 is a schematic cross-sectional view of a glass diaphragm according to a third modification.

FIG. 12 is a schematic cross-sectional view of a glass diaphragm according to a fourth modification.

FIG. 13A is a schematic cross-sectional view of a glass diaphragm according to a fifth modification.

FIG. 13B is a plan view of a mounting member on a side fixed to a glass plate structure according to the fifth modification.

FIG. 14 is a schematic cross-sectional view of a glass diaphragm according to a sixth modification.

FIG. 15 is a schematic cross-sectional view of a glass diaphragm according to a seventh modification.

FIG. 16 is a schematic cross-sectional view of a glass diaphragm according to an eighth modification.

FIG. 17 is a plan view of a mounting member, illustrating a modification of disposition of through holes.

FIG. 18 is a schematic cross-sectional view of a glass diaphragm, illustrating a modification of a second adhesive layer.

### DESCRIPTION OF EMBODIMENTS

Hereinafter, an embodiment of the present invention will be described in detail with reference to the drawings. An exciter-attached glass diaphragm according to the present embodiment includes a glass diaphragm and an exciter configured to vibrate the glass diaphragm, and can be applied to, for example, an application for vibrating a vehicular glass plate. In the following description, an example will be described in which the exciter-attached glass diaphragm is applied to a window portion such as a side window of a vehicle, but the application is not limited to this.

### Overall Configuration of Glass Diaphragm

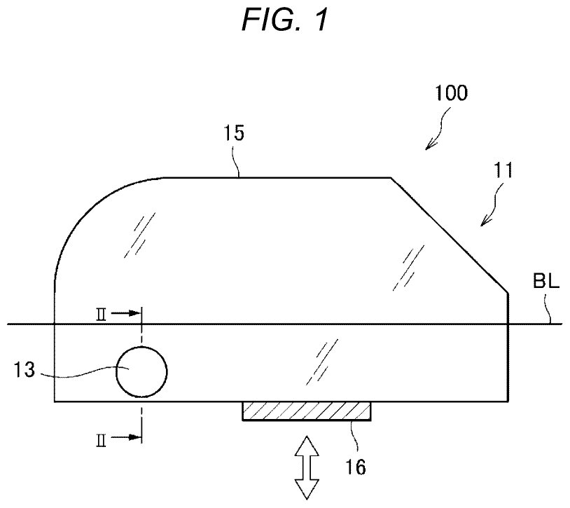

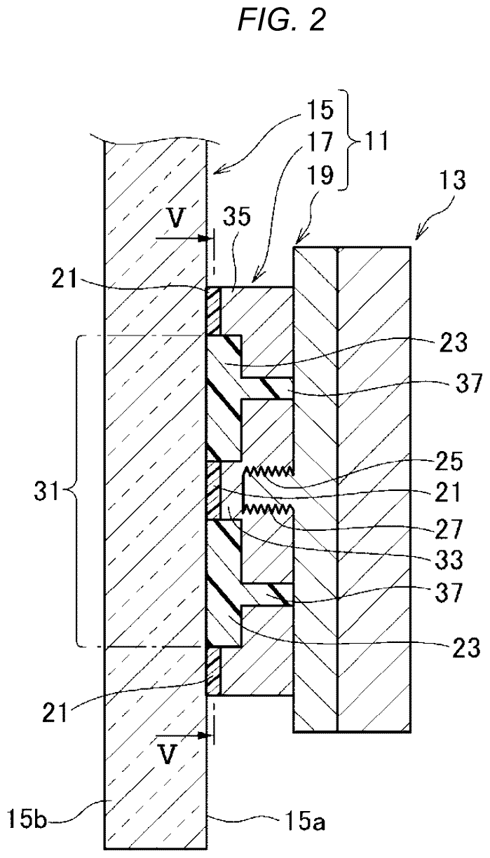

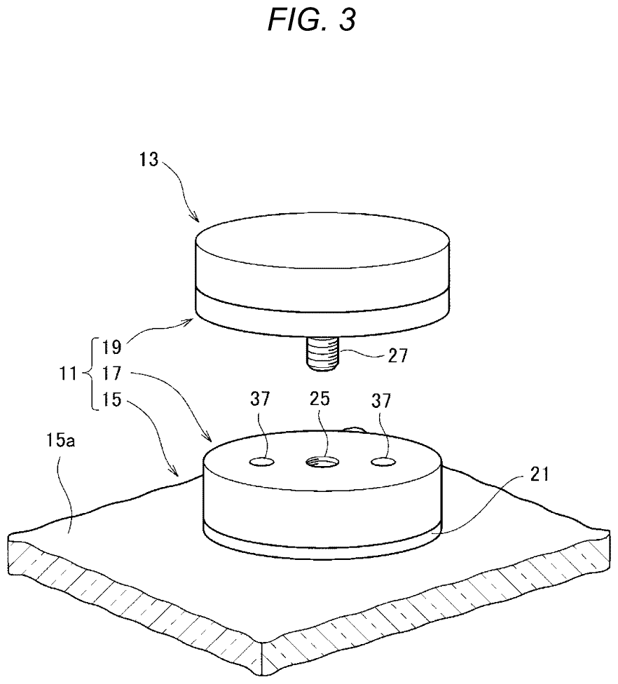

FIG. 1 is a schematic plan view of a glass diaphragm 11. FIG. 2 is a schematic cross-sectional view of the glass diaphragm 11 taken along a line II-II in FIG. 1. FIG. 3 is a perspective view of a mounting member 17 and an exciter 13 fixed to a glass plate structure 15.

As shown in FIG. 1 to FIG. 3, in the glass diaphragm 11, the exciter 13 for generating vibration is mountable to a main surface of the glass plate structure 15. Specifically, the glass diaphragm 11 includes the glass plate structure 15, the mounting member 17, and a connection member 19.

### Configuration of Exciter-attached Glass Diaphragm

An exciter-attached glass diaphragm 100 has a configuration in which the exciter 13 is mounted to the glass diaphragm 11. The exciter 13 is connected and fixed to the connection member 19, and the connection member 19 is fixed to the mounting member 17. The exciter 13 is fixed to the connection member 19 by at least one of a mechanical fastening method such as a screw, a bolt and a nut, a rivet, a key, and a pin, and an adhesive. Note that, the exciter 13 and the connection member 19 may be configured to be firmly fixed to each other using different members, or may be configured to be integrated into one body using the same member. The connection member 19 is mechanically fixed to the mounting member 17. The mounting member 17 is fixed to a first main surface 15a, which is one of main surfaces of the glass plate structure 15. Accordingly, the exciter 13 is mounted to the first main surface 15a of the glass plate structure 15 via the connection member 19 and the mounting member 17.

For example, when the glass diaphragm 11 is used as a side window of a vehicle, the exciter 13 is disposed in a region below a belt line BL, that is, in a region on a frame 16 side of a lifting mechanism (not shown). Accordingly, sound generated from the glass plate structure 15 can be supplied to the inside of the vehicle. Note that, the belt line BL corresponds to a lower side of an opening when the side window is fully closed once the side window is attached to the vehicle (door).

The exciter 13 is a vibration device that uses an object that it comes into contact with as a diaphragm and generates sound from the diaphragm. The exciter-attached glass diaphragm 100 with the exciter 13 mounted thereto generates desired sound by vibrating the glass diaphragm 11 when the exciter 13 is driven. The exciter 13 used here may be an exciter (not shown) that includes a coil portion electrically connected to an external device, a magnetic circuit portion, and a vibration portion. With this exciter, when an electric signal of sound from the external device is input to the coil portion, the coil portion or the magnetic circuit portion vibrates due to interaction between the coil portion and the magnetic circuit portion. The vibration of the coil portion or the magnetic circuit portion is transmitted to the vibration portion, and the vibration portion generates vibration. Note that, the exciter 13 is provided with a conductive wire (not shown) for driving the exciter 13.

### Glass Plate Structure

The glass plate structure 15 constituting the glass diaphragm 11 includes the first main surface 15a and a second main surface 15b. Here, the glass plate structure 15 is exemplified as a single glass plate (single plate glass), but it may have another form, such as a laminated glass in which an intermediate layer such as a resin interlayer or a liquid is sandwiched between a pair of glass plates. A thickness of the glass plate structure 15 is preferably 1 [mm] or more, more preferably 2 [mm] or more, and still more preferably 3 [mm] or more. Accordingly, the strength of the glass plate structure 15 can be made sufficient as required.

### Mounting Member

The mounting member 17 can be formed of a metal material such as aluminum or an aluminum alloy, a titanium alloy, a magnesium alloy, or stainless steel, or a material such as a ceramic, a glass, a resin material, a carbon fiber, or a composite material made of these. Examples of the resin material include acrylic resins such as a polymethyl methacrylate resin (PMMA), a polycarbonate (PC), polyvinyl chloride (PVC), urethane, a polypropylene (PP), polybutylene terephthalate (PBT), polyphenylene sulfide (PPS), a polystyrene (PS), nylon 66, and an ABS resin, which have excellent formability. Further, the above material is more preferably a fiber-reinforced plastic containing a glass fiber or a carbon fiber. By using the above materials, a sufficient connection strength can be obtained without causing cracks or the like in the mounting member 17. The mounting member 17 may be made of a single material, but may also be made of a composite material such as an aluminum alloy and stainless steel, or a resin material and stainless steel.

The mounting member 17 is formed in a circular shape in a plan view of the glass plate structure 15, and is adhesively fixed to the first main surface 15a of the glass plate structure 15. Note that, an outer edge shape of the mounting member 17 in the plan view of the glass plate structure 15 is not limited to a circular shape, and may be any shape such as a polygon. In addition, a first adhesive layer 21 and a second adhesive layer 23 are disposed between the glass plate structure 15 and the mounting member 17. The mounting member 17 is adhesively fixed to the first main surface 15a of the glass plate structure 15 by the first adhesive layer 21 and the second adhesive layer 23.

The mounting member 17 includes a screw hole 25 on a side opposite to a side fixed to the glass plate structure 15. The connection member 19 provided on the exciter 13 has a screw shaft 27, and the connection member 19 is fastened to the mounting member 17 by screwing this screw shaft 27 into the screw hole 25 of the mounting member 17 adhesively fixed to the glass plate structure 15.

In this way, the connection member 19 fixed to the exciter 13 is mechanically fixed to the mounting member 17 adhesively fixed to the glass plate structure 15, and the exciter 13 is stably attached to the glass plate structure 15. In addition, when the connection member 19 screwed into the mounting member 17 is loosened, the exciter 13 (in this case, a member to which the exciter 13 and the connection member 19 are fixed) can be removed from the glass plate structure 15, so that the exciter 13 can be easily replaced. Note that, the screw structure between the connection member 19 and the mounting member 17 is not limited to a combination of the connection member 19 having a convex screw portion and the mounting member 17 having a concave screw portion screwed thereto, but may also be a combination of the connection member 19 having a concave screw portion and the mounting member 17 having a convex screw portion screwed thereto. Further, the fixing structure between the mounting member 17 and the connection member 19 is not limited to the screw structure, but may be, for example, a mechanical fastening method such as a rivet, a key, or a pin.

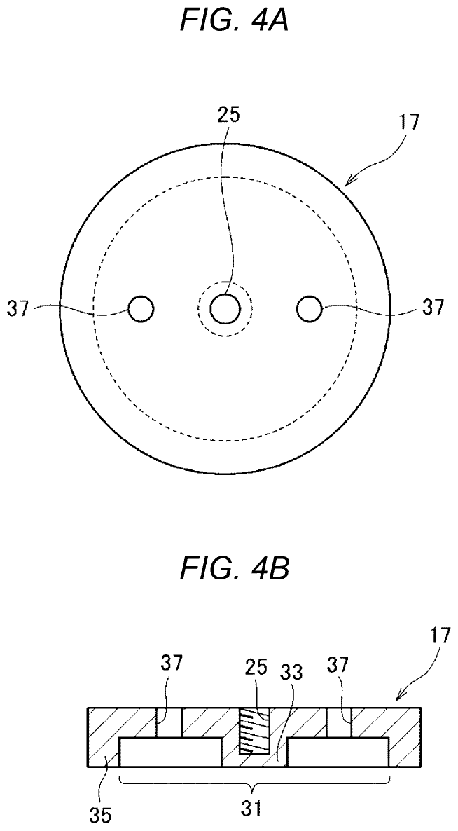

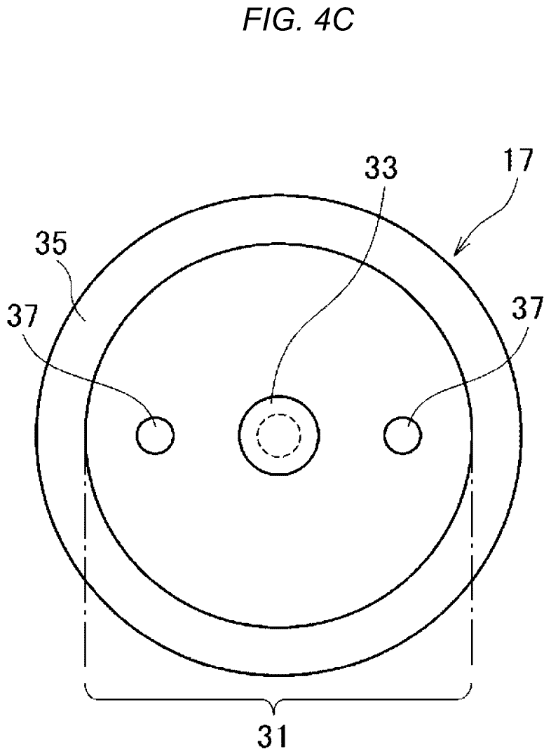

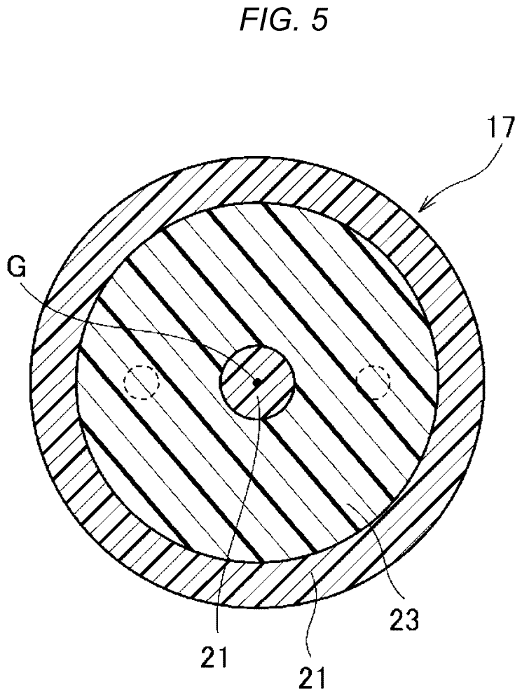

FIG. 4A to FIG. 4C are diagrams showing the mounting member 17. FIG. 4A is a plan view of the mounting member 17 on the side opposite to the side fixed to the glass plate structure 15. FIG. 4B is a cross-sectional view of the mounting member 17 in a thickness direction. FIG. 4C is a plan view of the mounting member 17 on the side fixed to the glass plate structure 15.

As shown in FIG. 4A to FIG. 4C, the mounting member 17 has a recessed portion 31 on the side fixed to the glass plate structure 15, and an outer side of the recessed portion 31 is provided with an annular protrusion portion 35 that protrudes from a bottom surface of the recessed portion 31 toward the side fixed to the glass plate structure 15. In addition, the mounting member 17 has, in a central portion on the side fixed to the glass plate structure 15, a central protrusion portion 33 that protrudes from the bottom surface of the recessed portion 31 toward the side fixed to the glass plate structure 15. Here, the central portion is a region (portion) that includes a center of gravity of the mounting member 17 in the plan view of the glass plate structure 15 and that is surrounded by a circular shape having an outer edge more outward than an outer edge of the screw hole 25, as shown in FIG. 4B and FIG. 4C, or may be a region (portion) other than the circular shape. Accordingly, the recessed portion 31 is formed in an annular shape. In addition, the mounting member 17 has a plurality of (two in this example) through holes 37 penetrating in the thickness direction in the recessed portion 31. These through holes 37 have a width smaller than a width of the second adhesive layer 23. Note that, the through hole 37 may penetrate in a direction inclined with respect to the mounting member 17, or may penetrate in a radial direction with respect to the mounting member 17.

FIG. 5 is a schematic cross-sectional view taken along a line V-V in FIG. 2.

As shown in FIG. 2 and FIG. 5, the first adhesive layer 21 is disposed on the central protrusion portion 33 and the annular protrusion portion 35 of the mounting member 17, and the second adhesive layer 23 is disposed in the recessed portion 31 of the mounting member 17. The mounting member 17 is adhesively fixed to the glass plate structure 15 by the first adhesive layer 21 and the second adhesive layer 23. Accordingly, the mounting member 17 to which the exciter 13 or a member in which the connection member 19 and the exciter 13 are integrated is fixed can be easily adhesively fixed to the glass plate structure 15 with a simple structure.

### Adhesive Layer

The first adhesive layer 21 and the second adhesive layer 23 that adhesively fix the mounting member 17 to the glass plate structure 15 are made of different materials. One of the first adhesive layer 21 and the second adhesive layer 23 made of different materials is preferably an adhesive layer having excellent handleability and having good vibration transmissibility. Accordingly, the workability of attaching the mounting member 17 to the glass plate structure 15 is improved, and the vibration from the exciter 13 can be smoothly transmitted to the glass plate structure 15, thereby improving the acoustic effect. In addition, the other of the first adhesive layer 21 and the second adhesive layer 23 made of different materials is preferably an adhesive layer having a high adhesive force. Accordingly, the glass plate structure 15 and the mounting member 17 are firmly fixed to each other, the exciter 13 or the member in which the connection member 19 and the exciter 13 are integrated can be stably attached to the glass plate structure 15, and a decrease in quality of sound emitted from the glass diaphragm 11 and falling off of the exciter due to displacement of the exciter 13 can be prevented.

As the first adhesive layer 21, for example, it is preferable to use a pressure-sensitive adhesive or a pressure-sensitive adhesive tape that exhibits adhesiveness in a short time, and it may have a multi-layer structure including a base material portion. As the pressure-sensitive adhesive or the pressure-sensitive adhesive tape, acrylic-based, silicone-based, urethane-based, natural rubber-based, epoxy silicone-based, cyanoacrylate-based materials and the like can be used. The first adhesive layer 21 may be made of a moisture-curing adhesive such as an instant adhesive, or a light-curing adhesive that is curable by ultraviolet light or visible light. As such an adhesive, cyanoacrylate-based, acrylic-based, epoxy-based, urethane-based, epoxy silicone-based materials and the like can be used.

As the second adhesive layer 23, for example, it is preferable to use a curable adhesive. As such an adhesive, acrylic-based, silicone-based, urethane-based, epoxy-based, epoxy silicone-based, vinyl acetate-based, vinyl chloride-based, chloroprene rubber-based, nitrile rubber-based, cyanoacrylate-based, synthetic rubber-based, EVA resin-based, polyimide-based, and phenol-based adhesives and the like can be used. In addition, as the adhesive, chemically reactive adhesives such as thermosetting, moisture-curing, two-part mixture curing, ultraviolet-curing, visible light-curing, and anaerobic curing adhesives; hot melt adhesives; combined reactive adhesives such as ultraviolet and heat combined, ultraviolet and moisture-curing combined, ultraviolet and anaerobic curing combined, hot melt and moisture-curing combined, and adhesive and ultraviolet-curing combined adhesives can be used.

Note that, the second adhesive layer 23 has a Young's modulus of 1×10⁵ [Pa] or more. Accordingly, the vibration from the exciter 13 can be smoothly transmitted to the glass plate structure 15, and a large fixing strength of the mounting member 17 to the glass plate structure 15 can be obtained. Note that, the Young's modulus of the second adhesive layer 23 is preferably 1×10⁹ [Pa] or less, and more preferably 1×10⁸ [Pa] or less.

Note that, the Young's modulus in the present description is a value measured using an autograph or rheometer based on JIS K 7161: 2014 “Plastics—Determination of tensile properties”.

In addition, when a surface area of the first adhesive layer 21 in contact with the glass plate structure 15 is S1, and a surface area of the second adhesive layer 23 in contact with the glass plate structure 15 is S2, a ratio S1:S2 preferably satisfies a range of 1:0.01 to 1:100. Accordingly, the surface areas of the first adhesive layer 21 and the second adhesive layer 23 in contact with the glass plate structure 15 can be set to have an appropriate ratio, and the mounting member 17 can satisfactorily adhere to the glass plate structure 15 by the first adhesive layer 21 and the second adhesive layer 23. Note that, each of S1 and S2 preferably has a large area, and S1:S2 more preferably satisfies a ratio in a range of 1:0.05 to 1:20, and still more preferably satisfies a ratio in a range of 1:0.1 to 1:10, from two viewpoints of ensuring the vibration transmissibility and the fixing strength.

In addition, in the glass diaphragm 11 according to this configuration example, the first adhesive layer 21 and the second adhesive layer 23 are in contact with both the glass plate structure 15 and the mounting member 17. Therefore, the glass plate structure 15 and the mounting member 17 can be fixed to each other in a short time by the first adhesive layer 21, and the glass plate structure 15 and the mounting member 17 can be fixed to each other with a large fixing strength for a long period of time by the second adhesive layer 23.

In addition, the first adhesive layer 21 and the second adhesive layer 23 have a portion in contact with each other in a direction along the first main surface 15a of the glass plate structure 15. Accordingly, a gap between the first adhesive layer 21 and the second adhesive layer 23 is reduced, and the adhesive strength is increased.

Further, the first adhesive layer 21 is disposed on the central protrusion portion 33 and the annular protrusion portion 35 of the mounting member 17, and the second adhesive layer 23 is disposed in the recessed portion 31 of the mounting member 17. Therefore, in the plan view of the glass plate structure 15, the first adhesive layer 21 disposed on the annular protrusion portion 35 of the mounting member 17 is disposed outside the second adhesive layer 23 based on a center of gravity G of the mounting member 17 (see FIG. 5). Accordingly, the mounting member 17 can be satisfactorily fixed to the glass plate structure 15 in a well-balanced manner. Note that, in the plan view of the glass plate structure 15, the first adhesive layer 21 disposed outside the second adhesive layer 23 may be disposed to protrude outside the mounting member 17. In this way, when the first adhesive layer 21 protrudes outside the mounting member 17, for example, in the case of using a pressure-sensitive adhesive tape as the first adhesive layer 21, since an outwardly protruding portion is provided as a peeling allowance in peeling off release paper, a decrease in yield in a release paper peeling process can be reduced.

In addition, the first adhesive layer 21 disposed outside the second adhesive layer 23 is disposed in a closed loop shape surrounding the second adhesive layer 23 (see FIG. 5). Accordingly, the second adhesive layer 23 can be surrounded and protected by the first adhesive layer 21, and the durability of an adhesively fixed portion by the second adhesive layer 23 is improved. For example, when a liquid or gel adhesive is used as the second adhesive layer 23, with the mounting member 17 adhering to the glass plate structure 15 by the first adhesive layer 21, an adhesive to be the second adhesive layer 23 can be used for filling and can be disposed inside the first adhesive layer 21 without leaking out. In this case, a through hole or the like may be provided to allow the adhesive to be the second adhesive layer 23 to leak out to the outside of the first adhesive layer 21 so as to increase an adhesive area between the glass plate structure 15 and the adhesive, thereby improving the adhesive strength between the glass plate structure 15 and the mounting member 17. In addition, a moisture-curing adhesive may be used for the second adhesive layer 23, in which case the curing time can be shortened.

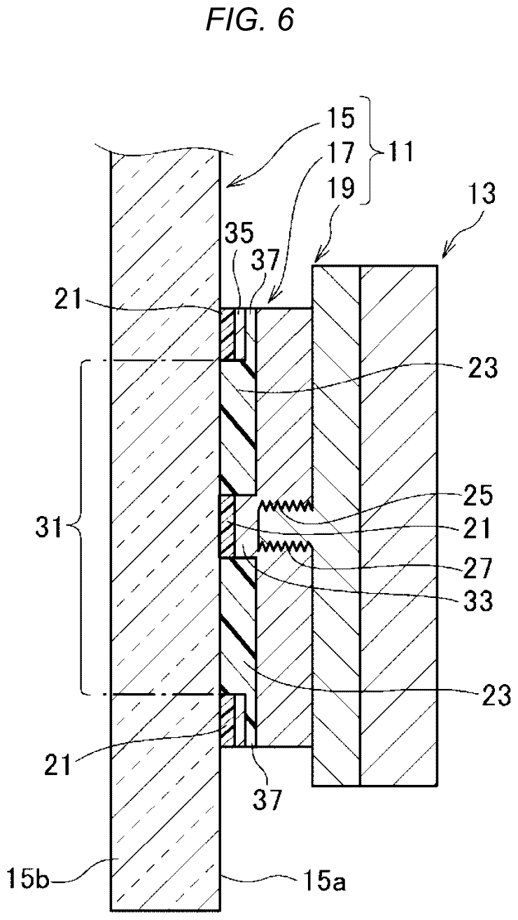

FIG. 6 is a schematic cross-sectional view of the glass diaphragm 11 including the mounting member 17 having through holes 37 in a side wall surface. As shown in FIG. 6, the through holes 37 are formed in the side wall surface of the mounting member 17, and the adhesive to be the second adhesive layer 23 may be used for filling through one of the through holes 37 serving as an inlet. Accordingly, even when the adhesive unintentionally leak out or is allowed to leak out of the other through hole 37 serving as an outlet, adhesion of the adhesive to an upper surface of the mounting member 17 is prevented. That is, the adhesive to be the second adhesive layer 23 can be used for filling without adhering the adhesive to the upper surface of the mounting member 17 serving as an attachment surface of the connection member 19 fixed to the exciter 13. Accordingly, it is possible to prevent the formation of unintended irregularities on the upper surface of the mounting member 17 due to the adhesive to be the second adhesive layer 23 leaking out of the through hole 37, and to allow the connection member 19 to be attached in close contact with the mounting member 17. Therefore, the vibration of the exciter 13 can be transmitted more effectively to the glass plate structure 15 via the mounting member 17. Note that, there may be a plurality of through holes 37 serving as the inlet, and there may also be a plurality of through holes 37 serving as the outlet. Further, a height position of the through hole 37 formed in the side wall surface is not limited to an upper portion of the mounting member, and may be set at any height.

The second adhesive layer 23 is made thicker than the first adhesive layer 21. Accordingly, for example, when a pressure-sensitive adhesive tape is used as the first adhesive layer 21 and a curable adhesive having a high adhesive strength is used as the second adhesive layer 23, the adhesive strength of the mounting member 17 to the glass plate structure 15 can be increased by the second adhesive layer 23 which is thicker than the first adhesive layer 21.

In addition, the first adhesive layer 21 has a portion disposed in the central protrusion portion 33 of the mounting member 17, and this portion is disposed in a central region including the center of gravity G of the mounting member 17 in the plan view of the glass plate structure 15. Accordingly, the central region including the center of gravity G of the mounting member 17 can satisfactorily adhere to the glass plate structure 15 by the first adhesive layer 21.

The glass diaphragm 11 according to this configuration example can be applied not only to a side window of vehicles such as an automobile, but also to a windshield, a rear window, a roof glazing, a front quarter window, a rear quarter window, and the like. Accordingly, this can greatly contribute to a stereophonic system in which the glass diaphragm 11 is combined with an existing speaker, a noise canceling system that cancels noise from outside the vehicle by applying sound waves of an opposite phase to the noise, and further, a reflection control system that cancels music reverberation inside the vehicle. In addition to vehicle windows, the glass diaphragm 11 can also be applied to a building window, a structural member, and a decorative panel, and can also be used as a diaphragm member for a flat panel speaker.

### Method for Producing Glass Diaphragm

Next, a method for producing the glass diaphragm 11 according to this configuration example will be described. Note that, in the following description, a case where a pressure-sensitive adhesive tape is used as the first adhesive layer 21 and a curable liquid or gel adhesive is used as the second adhesive layer 23 will be illustrated.

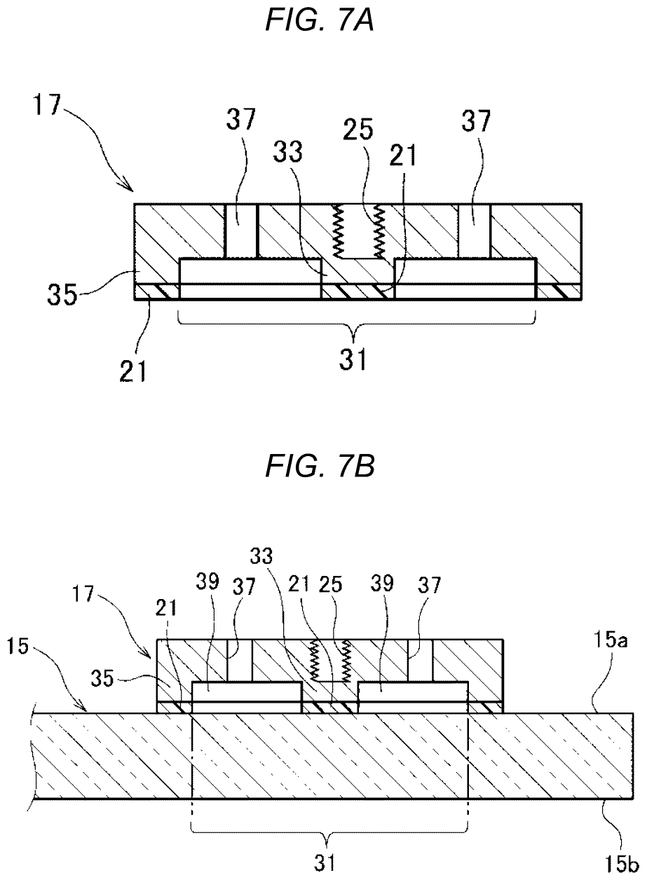

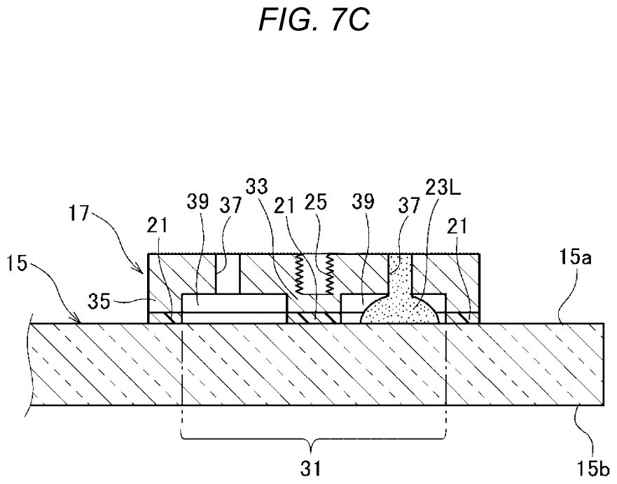

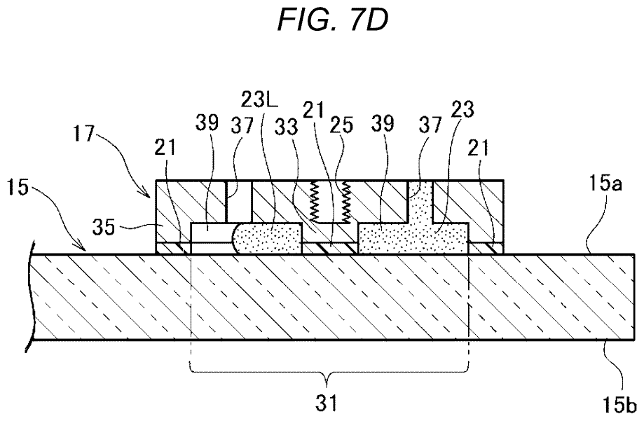

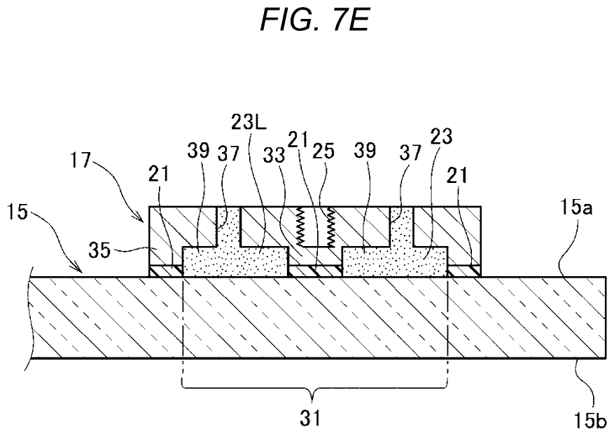

FIG. 7A to FIG. 7E are diagrams each illustrating a step in the method for producing the glass diaphragm 11.

### Preparation Step

As shown in FIG. 7A, the first adhesive layer 21 is disposed on a surface of the mounting member 17 facing the glass plate structure 15. Specifically, a pressure-sensitive adhesive tape to be the first adhesive layer 21 is attached to the central protrusion portion 33 and the annular protrusion portion 35 of the mounting member 17.

### First Adhesion Step

As shown in FIG. 7B, the mounting member 17, with the first adhesive layer 21 side facing the glass plate structure 15, is brought closer to the first main surface 15a of the glass plate structure 15, and the first adhesive layer 21 is brought into close contact with the glass plate structure 15 at a predetermined attachment position of the exciter 13. Accordingly, the glass plate structure 15 and the mounting member 17 adhere to each other via the first adhesive layer 21 made of a pressure-sensitive adhesive tape. At this time, by using a pressure-sensitive adhesive tape as the first adhesive layer 21, the mounting member 17 can be positioned and fixed to the glass plate structure 15 at the predetermined attachment position of the exciter 13 without waiting for a curing time and without dripping. In this way, when the mounting member 17 adheres to the first main surface 15a of the glass plate structure 15 via the first adhesive layer 21, an annular space 39 that communicates with the through holes 37 is formed in the mounting member 17 on the glass plate structure 15 side by the glass plate structure 15, the first adhesive layer 21, and the recessed portion 31 of the mounting member 17.

### Second Adhesion Step

As shown in FIG. 7C, of the through holes 37 in the mounting member 17, one serves as an inlet and the other serves as an outlet. A liquid or gel adhesive 23L to be the second adhesive layer 23 is injected through the through hole 37 serving as the inlet, and the annular space 39 formed in the mounting member 17 on the glass plate structure 15 side is filled with the adhesive 23L. Then, the annular space 39 is smoothly filled with the adhesive 23L from the through hole 37 having a width smaller than the width of the second adhesive layer 23 made of this adhesive 23L. When the liquid or gel adhesive 23L has too high a shear viscosity, the resistance during filling is too large, and the injection process takes a long time. The upper limit of the shear viscosity is preferably 1 [MPa·s] or less, more preferably 100 [kPa·s] or less, and still more preferably 10 [kPa·s] or less, within the range of a shearing speed of 0.1 to 100 [1/sec], with no lower limit.

As shown in FIG. 7D, the adhesive 23L flows around the annular space 39 and is fed into the entire space 39. At this time, the air inside the space 39 is discharged, by the adhesive 23L for filling, to the outside through the other through hole 37 as the outlet. Therefore, the space 39 can be smoothly filled with the adhesive 23L injected through the through hole 37 serving as the inlet. Note that, the adhesive 23L for filling the inside of the space 39 is filled from below by gravity. Therefore, when the mounting member 17 is disposed on the glass plate structure 15 with the first main surface 15a facing upward, and the adhesive 23L is used for filling using one of the through holes 37 located above as the outlet, the inside of the space 39 can be filled with the adhesive 23L without gaps. At this time, since an outer periphery of the space 39 is sealed by the loop-shaped first adhesive layer 21 adhering to the first main surface 15a of the glass plate structure 15, the inside of the space 39 can be smoothly filled with the liquid or gel adhesive 23L to be the second adhesive layer 23 without leaking out. Note that, as described above, the adhesive 23L may be allowed to leak out to the outside of the space 39 to adhere to the glass plate structure body 15.

As shown in FIG. 7E, when the entire space 39 is filled with the adhesive 23L, the adhesive 23L enters the through hole 37 serving as the outlet. At this time, when the adhesive 23L to be the second adhesive layer 23 is visually observed at the through hole 37 serving as the outlet, a state where the space 39 in the mounting member 17 on the glass plate structure 15 side is filled with the adhesive 23L can be easily seen.

Next, when the adhesive 23L for filling the space 39 in the mounting member 17 on the glass plate structure 15 side is cured, the mounting member 17 is adhesively fixed to the glass plate structure 15 by the first adhesive layer 21 and the second adhesive layer 23 made of the cured adhesive 23L.

Thereafter, by fixing the connection member 19 to the mounting member 17 and attaching the exciter 13, the exciter-attached glass diaphragm 100, which includes the exciter 13, is obtained.

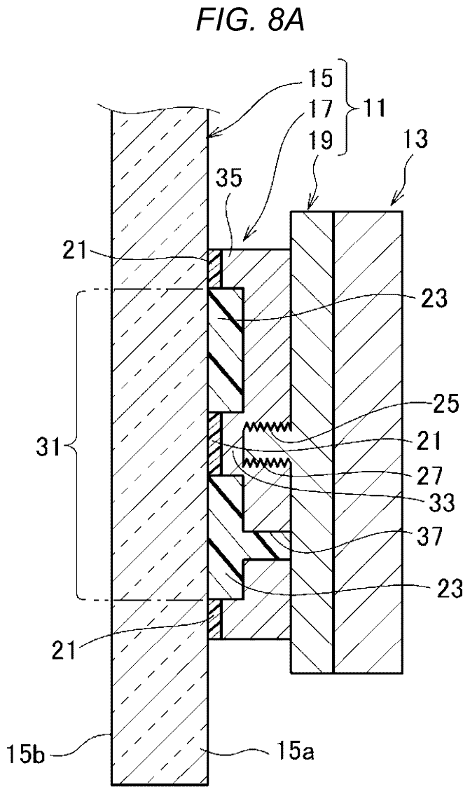

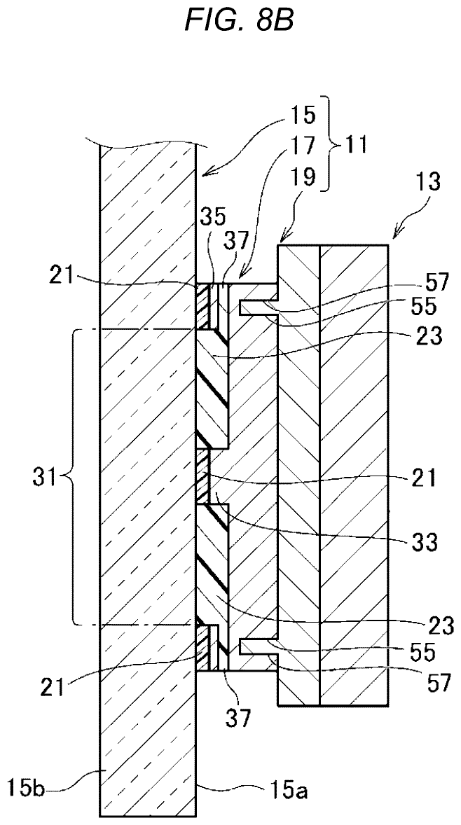

Note that, as shown in FIG. 8A, the mounting member 17 may have only one through hole 37. In the case of adhering this mounting member 17 to the glass plate structure 15, in a filling step using the adhesive 23L to be the second adhesive layer 23 (second adhesion step), one through hole 37 is used as an inlet, and the space 39 is filled with the adhesive 23L to be the second adhesive layer 23 through this through hole 37. In this case, it is preferable to reduce the pressure inside the space 39 using a vacuum pump or the like before filling using the adhesive 23L. In this way, by reducing the pressure inside the space 39, the adhesive 23L can be smoothly injected though one through hole 37, with which the entire space 39 is filled.

In addition, as shown in FIG. 8B, the mounting member 17 may have a plurality of attachment holes 55 on the side opposite to the side fixed to the glass plate structure 15. When the mounting member 17 has a plurality of attachment holes 55, the connection member 19 provided on the exciter 13 also has a plurality of protrusions 57 corresponding to the plurality of attachment holes 55, and by fitting the plurality of protrusions 57 into the plurality of attachment holes 55, the connection member 19 can be firmly fastened to the mounting member 17. Examples of the protrusion 57 include fastening members such as a rivet, a pin, a key, and a bolt.

In addition, as the adhesive 23L, an adhesive that expands during the curing process may be used. In this case, the adhesive 23L injected into the space 39 through one through hole 37 expands inside the space 39, filling the entire space 39.

Note that, the mounting member 17 may have a configuration that does not has the through hole 37. In the case of using this mounting member 17, a pressure-sensitive adhesive tape to be the first adhesive layer 21 is attached to the central protrusion portion 33 and the annular protrusion portion 35 of the mounting member 17, and further, the annular recessed portion 31 of the mounting member 17 is filled with the gel adhesive 23L having a high viscosity. Then, this mounting member 17 is brought closer to the first main surface 15a of the glass plate structure 15 and brought into close contact with the glass plate structure 15 at the predetermined attachment position of the exciter 13, and the glass plate structure 15 and the mounting member 17 adhere to each other via the first adhesive layer 21 made of a pressure-sensitive adhesive tape. Thereafter, the adhesive 23L is cured to be the second adhesive layer 23, and the mounting member 17 is thereby adhesively fixed to the glass plate structure 15 by the first adhesive layer 21 and the second adhesive layer 23.

In the above production method, a pressure-sensitive adhesive tape may be used as the second adhesive layer 23, and a liquid or gel adhesive may be used as the first adhesive layer 21. In this case, the mounting member 17 adheres to the glass plate structure 15 by the second adhesive layer 23 made of a pressure-sensitive adhesive tape, and then a gap between the glass plate structure 15 and the mounting member 17 is filled with a liquid or gel adhesive from an outer periphery side of the mounting member 17. In this case, it is preferable to dispose the first adhesive layer 21 made of a pressure-sensitive adhesive tape on the central protrusion portion 33 of the mounting member 17.

Note that, in the above configuration example, a case where the mounting member 17 having a circular shape in a plan view is used is illustrated, but the mounting member 17 may have a polygonal shape in a plan view, such as a triangle or a rectangle.

The fixing structure between the glass plate structure 15 and the mounting member 17 in the glass diaphragm 11 according to this configuration example described above is merely an example, and can be modified to various configurations.

Hereinafter, modifications of the fixing structure between the glass plate structure 15 and the mounting member 17 will be described. Note that, in the following description, the same or corresponding reference numeral is imparted to the same or corresponding portions or members, and duplicated description is thereby omitted.

### First Modification

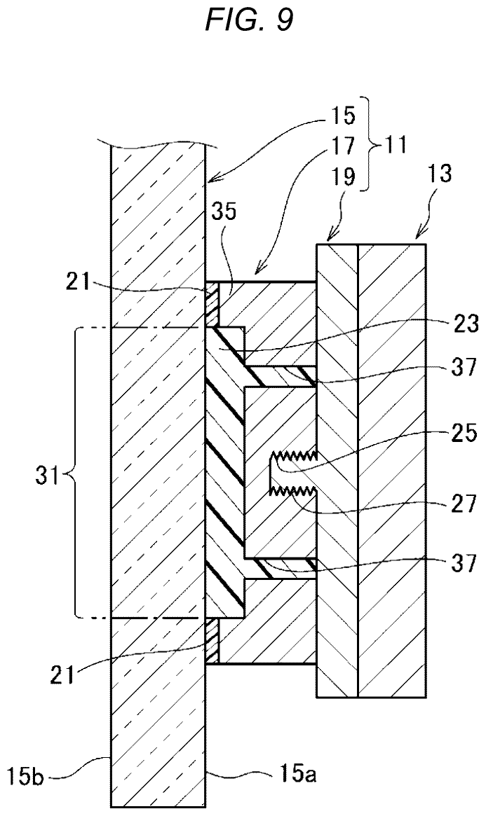

FIG. 9 is a schematic cross-sectional view of the glass diaphragm 11 according to a first modification.

As shown in FIG. 9, in the glass diaphragm 11 according to the first modification, the mounting member 17 has the recessed portion 31 having a circular shape on the side fixed to the glass plate structure 15. That is, the mounting member 17 does not have the central protrusion portion 33 but only has the annular protrusion portion 35 on the side fixed to the glass plate structure 15. In addition, the mounting member 17 includes the second adhesive layer 23 disposed in the recessed portion 31 having a circular shape on the side fixed to the glass plate structure 15. In this first modification, a central region of the mounting member 17 is firmly adhesively fixed to the glass plate structure 15 by the second adhesive layer 23.

### Second Modification

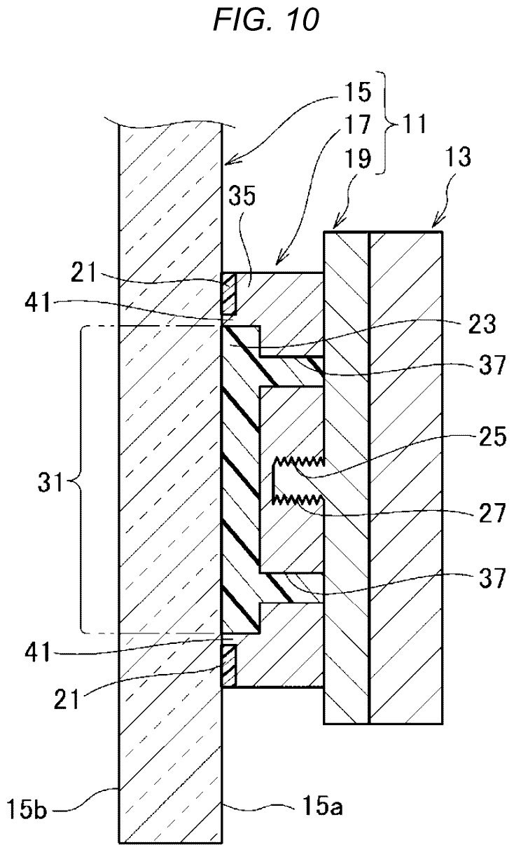

FIG. 10 is a schematic cross-sectional view of the glass diaphragm 11 according to a second modification.

As shown in FIG. 10, in the glass diaphragm 11 according to the second modification, the mounting member 17 has the recessed portion 31 having a circular shape on the side fixed to the glass plate structure 15. In addition, the mounting member 17 has an annular wall portion 41 between the recessed portion 31 and the annular protrusion portion 35, which protrudes in a circumferential direction toward the side fixed to the glass plate structure 15.

In the glass diaphragm 11 according to the second modification, the recessed portion 31 in which the second adhesive layer 23 is disposed is surrounded by the annular wall portion 41. Therefore, when filling the recessed portion 31 with the adhesive 23L to be the second adhesive layer 23, the adhesive 23L is more satisfactorily blocked to prevent leaking out, thereby preventing waste of the adhesive 23L.

### Third Modification

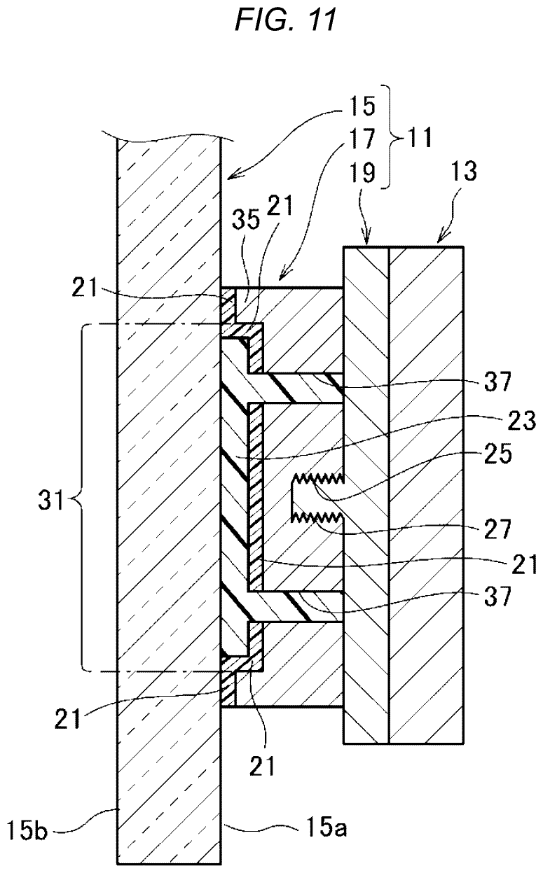

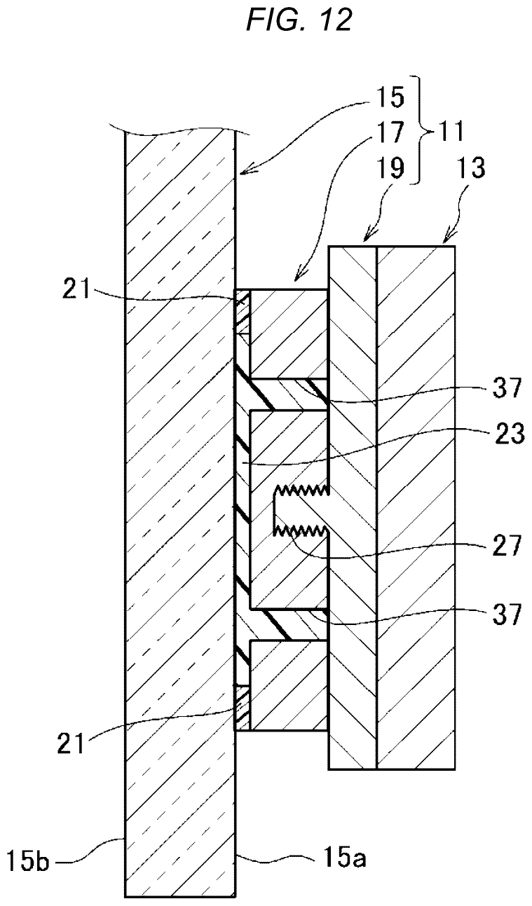

FIG. 11 is a schematic cross-sectional view of the glass diaphragm 11 according to a third modification.

As shown in FIG. 11, in the glass diaphragm 11 according to the third modification, the mounting member 17 has the recessed portion 31 having a circular shape on the side fixed to the glass plate structure 15. In addition, the mounting member 17 has the first adhesive layer 21 disposed on the annular protrusion portion 35 and an inner circumferential surface and a bottom surface of the recessed portion 31. In addition, the second adhesive layer 23 is disposed in the recessed portion 31 of the mounting member 17 whose inner circumferential surface and bottom surface are disposed with the first adhesive layer 21. Accordingly, in the recessed portion 31 of the mounting member 17, the first adhesive layer 21 and the second adhesive layer 23 overlap each other in the thickness direction. In this third modification, the central region of the mounting member 17 is also firmly adhesively fixed to the glass plate structure 15 by the second adhesive layer 23.

### Fourth Modification

FIG. 12 is a schematic cross-sectional view of the glass diaphragm 11 according to a fourth modification.

As shown in FIG. 12, in the glass diaphragm 11 according to the fourth modification, the mounting member 17 has a flat surface on the side fixed to the glass plate structure 15. In addition, the first adhesive layer 21 is disposed in an annular portion along an outer edge of a surface of the mounting member 17 on the side fixed to the glass plate structure 15, the second adhesive layer 23 is disposed inside this first adhesive layer 21, and the first adhesive layer 21 and the second adhesive layer 23 have approximately the same thickness.

In the glass diaphragm 11 according to the fourth modification, the central region of the mounting member 17 is also firmly adhesively fixed to the glass plate structure 15 by the second adhesive layer 23. In addition, in the fourth modification, since the surface of the mounting member 17 on the side fixed to the glass plate structure 15 is a flat surface, the mounting member 17 can be easily formed.

### Fifth Modification

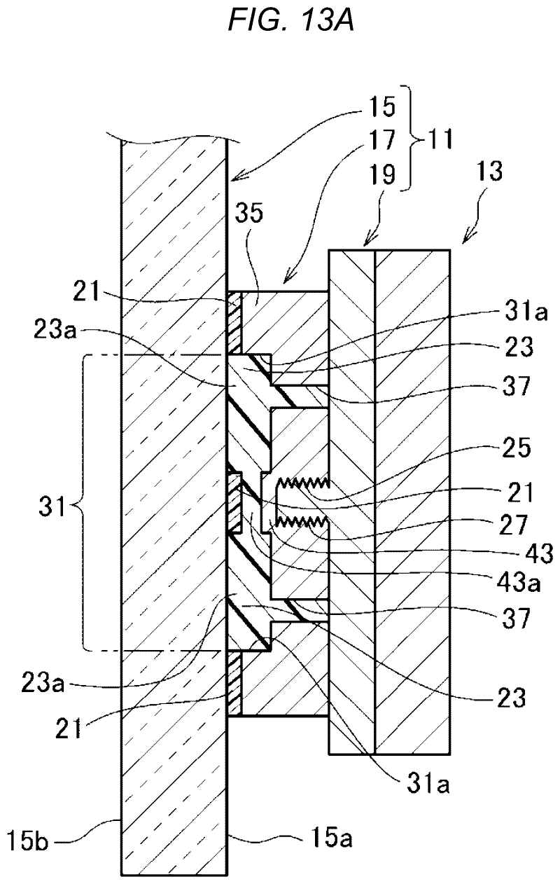

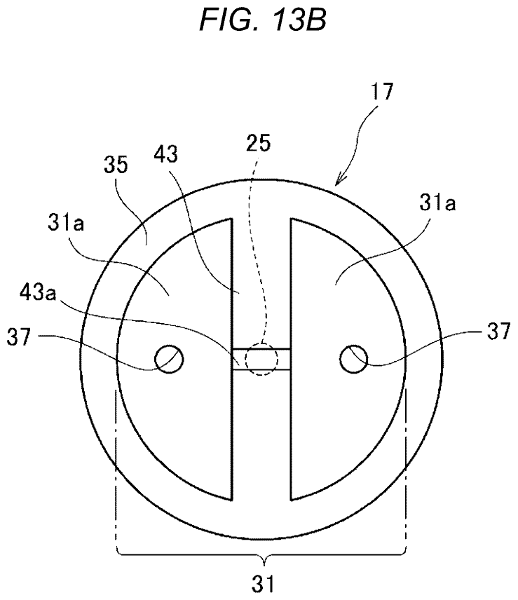

FIG. 13A is a schematic cross-sectional view of the glass diaphragm 11 according to a fifth modification. FIG. 13B is a plan view of the mounting member 17 used in the fifth modification, as viewed from the side fixed to the glass plate structure 15.

As shown in FIG. 13A and FIG. 13B, in the glass diaphragm 11 according to the fifth modification, the mounting member 17 is formed with a partition wall 43 on the side fixed to the glass plate structure 15. In addition, in the mounting member 17, the recessed portion 31 is divided by the partition wall 43 into two regions 31a each of which communicates with the corresponding through hole 37. Accordingly, the second adhesive layer 23 has two layers 23a filled with the adhesive 23L in respective regions 31a of the recessed portion 31. The partition wall 43 has a connection groove 43a on the side fixed to the glass plate structure 15. Accordingly, the regions 31a of the recessed portion 31 are connected to each other by the connection groove 43a, and the connection groove 43a is also filled with the adhesive 23L to be the second adhesive layer 23.

In the glass diaphragm 11 according to the fifth modification, the mounting member 17 has the annular protrusion portion 35 and the partition wall 43 adhering to the first main surface 15a of the glass plate structure 15 via a pressure-sensitive adhesive tape to be the first adhesive layer 21. Then, on the glass plate structure 15 side, the mounting member 17 is formed with two spaces communicating with the through holes 37 by the glass plate structure 15, the first adhesive layer 21, and the regions 31a of the recessed portion 31 of the mounting member 17. In addition, when the mounting member 17 adheres to the glass plate structure 15 by the first adhesive layer 21, a hole portion formed by the connection groove 43a of the partition wall 43 is formed in the mounting member 17 on the glass plate structure 15 side, and the spaces of the regions 31a communicate with each other through this hole portion. Therefore, when the space in one of the regions 31a is filled with the adhesive 23L to be the second adhesive layer 23 through one of the through holes 37, the space of the other of the regions 31a is filled with this adhesive 23L through the hole portion formed by the connection groove 43a, and the adhesive 23L enters the other of the through holes 37. Accordingly, the mounting member 17 is firmly fixed to the glass plate structure 15 by the first adhesive layer 21 and the second adhesive layer 23 including the two layers 23a. Note that, although FIG. 13B shows a case where the partition wall 43 has only one connection groove 43a, the partition wall 43 may have two or more connection grooves 43a.

### Sixth Modification

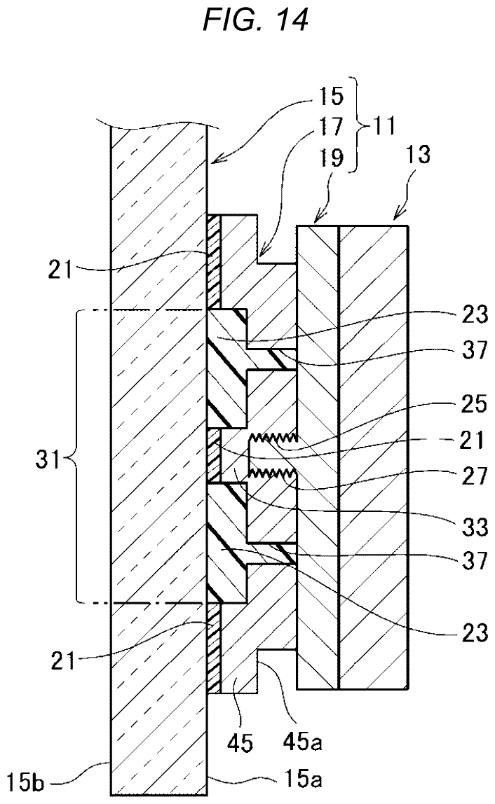

FIG. 14 is a schematic cross-sectional view of the glass diaphragm 11 according to a sixth modification.

As shown in FIG. 14, in the glass diaphragm 11 according to the sixth modification, the mounting member 17 has an enlarged diameter portion 45 whose diameter is enlarged on the side fixed to the glass plate structure 15. Accordingly, the mounting member 17 has a step 45a toward the glass plate structure 15. In the mounting member 17 having such a shape, an area on the glass plate structure 15 side can be made larger than an area on a side away from the glass plate structure 15 in the plan view of the glass plate structure 15.

In the glass diaphragm 11 according to the sixth modification, an area of the mounting member 17 on the side fixed to the glass plate structure 15 can be increased, and the adhesive strength of the mounting member 17 to the glass plate structure 15 by the first adhesive layer 21 and the second adhesive layer 23 can be increased.

Note that, in the glass diaphragm 11 according to the sixth modification, there is the step 45a formed by enlarging the diameter of the mounting member 17 on the side fixed to the glass plate structure 15. However, the mounting member 17 may have a truncated cone shape that is gradually enlarged in diameter toward the glass plate structure 15, and in this case, the area of the mounting member 17 on the side fixed to the glass plate structure 15 can also be increased.

### Seventh Modification

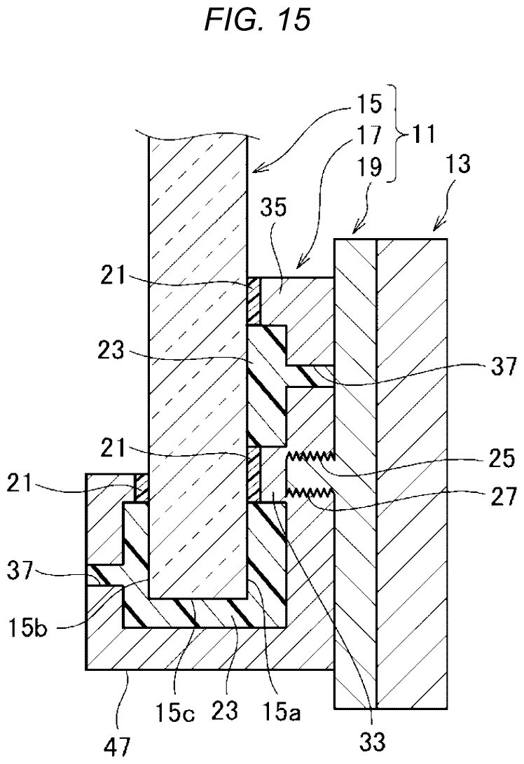

FIG. 15 is a schematic cross-sectional view of the glass diaphragm 11 according to a seventh modification.

As shown in FIG. 15, in the glass diaphragm 11 according to the seventh modification, the mounting member 17 has, on a part of an outer periphery thereof, an arm portion 47 formed in a U-shape in a cross-sectional view of the glass plate structure 15, and the through hole 37 is formed in this arm portion 47. The arm portion 47 of the mounting member 17 faces an end surface 15c connecting the first main surface 15a and the second main surface 15b of the glass plate structure 15, and also faces the second main surface 15b of the glass plate structure 15.

In addition, in the arm portion 47 of the mounting member 17, a portion facing the second main surface 15b of the glass plate structure 15 adhesively fixed to the second main surface 15b via the first adhesive layer 21 and the second adhesive layer 23 in the glass diaphragm 11 according to the seventh modification. Therefore, the mounting member 17 is adhesively fixed to both the first main surface 15a and the second main surface 15b of the glass plate structure 15, and the fixing strength of the mounting member 17 to the glass plate structure 15 can be increased.

Further, in the arm portion 47 the mounting member 17, a portion facing the end surface 15c of the glass plate structure 15 is in contact with the end surface 15c via the second adhesive layer 23 in the glass diaphragm 11 according to the seventh modification. Therefore, the second adhesive layer 23 is in contact with the first main surface 15a, the second main surface 15b, and the end surface 15c of the glass plate structure 15. Accordingly, the mounting member 17 is adhesively fixed to the end surface 15c by the second adhesive layer 23, in addition to being adhesively fixed to the first main surface 15a and the second main surface 15b, and the fixing strength to the glass plate structure 15 is further increased.

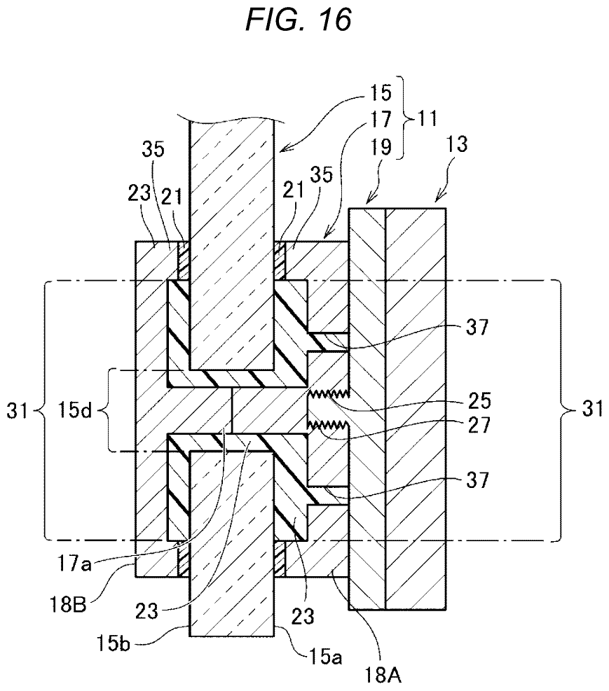

FIG. 16 is a schematic cross-sectional view of the glass diaphragm 11 according to an eighth modification.

As shown in FIG. 16, in the glass diaphragm 11 according to the eighth modification, a through hole 15d is formed in the glass plate structure 15, and the mounting member 17 is fixed to the glass plate structure 15 by penetrating the through hole 15d. The mounting member 17 includes divided bodies 18A and 18B on the first main surface 15a side and the second main surface 15b side of the glass plate structure 15. In addition, in this mounting member 17, one divided body 18A is mounted to the first main surface 15a side and the other divided body 18B is mounted to the second main surface 15b side of the glass plate structure 15, and the divided bodies 18A and 18B are joined to each other through the through hole 15d. In this way, the mounting member 17 includes the divided bodies 18A and 18B, and has a through portion 17a that penetrates the through hole 15d of the glass plate structure 15. The divided bodies 18A and 18B are fastened to each other by a screw structure, a rivet, or the like (not shown) and mechanically joined to each other.

In addition, in the mounting member 17 including the divided bodies 18A and 18B, the divided body 18A that is a portion facing the first main surface 15a of the glass plate structure 15 adhesively fixed to the first main surface 15a via the first adhesive layer 21 and the second adhesive layer 23 in the glass diaphragm 11 according to the eighth modification. Further, the divided body 18B that is a portion facing the second main surface 15b of the glass plate structure 15 adhesively fixed to the second main surface 15b via the first adhesive layer 21 and the second adhesive layer 23. Therefore, the mounting member 17 is adhesively fixed to both the first main surface 15a and the second main surface 15b of the glass plate structure 15, and the fixing strength of the mounting member 17 to the glass plate structure 15 can be increased.

Further, in the glass diaphragm 11 according to the eighth modification, the second adhesive layer 23 is disposed between the through hole 15d of the glass plate structure 15 and the through portion 17a of the mounting member 17 that penetrates this through hole 15d. Accordingly, the mounting member 17 is adhesively fixed to an end surface of the through hole 15d, which is an inner circumferential surface, by the second adhesive layer 23, in addition to being adhesively fixed to the first main surface 15a and the second main surface 15b, and the fixing strength to the glass plate structure 15 is further increased.

In this eighth modification, since the mounting member 17 penetrates the through hole 15d of the glass plate structure 15, the exciter 13 can be stably attached to the glass plate structure 15. In particularly, in this eighth modification, a risk of the mounting member 17 peeling off and falling off from the glass plate structure 15 is greatly reduced. Further, the mounting member 17 may be provided with an antenna or radar function that transmits radio waves through the through hole 15d of the glass plate structure 15. In addition, the mounting member 17 may be provided with a temperature sensor, a humidity sensor, an acceleration sensor, a rain sensor, a pressure sensor, and the like, and various types of information may be fed back from the mounting member 17 to the automobile.

As described above, the present invention is not limited to the embodiment described above, and combinations of the configurations in the embodiment with each other, modifications and applications by those skilled in the art based on the description of the specification and known techniques are also contemplated by the present invention and are included in the scope of protection.

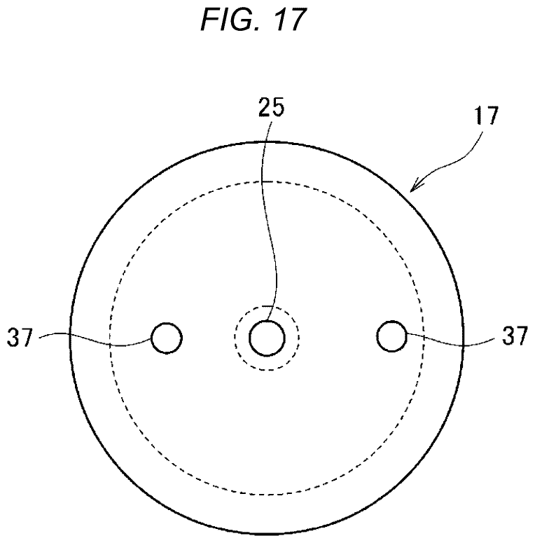

For example, in the figures illustrating the above configuration example and modifications, such as FIG. 2 and FIG. 9, an example has been described in which the mounting member 17 has two through holes 37, and these through holes 37 are disposed symmetrically with respect to a central axis of the mounting member 17 in the plan view of the glass plate structure 15, but the present invention is not limited to this disposition. As an example, as shown in FIG. 17, one through hole 37 may be disposed at a position farther away from the central axis than the other through hole 37. In this case, when the through hole 37 serving as an inlet is disposed at a position away from a wall surface of the mounting member 17 that forms the space 39, the resistance from the wall surface is reduced when the adhesive to be the second adhesive layer 23 is injected into the space 39, making it easier to inject the adhesive. On the other hand, when the through hole 37 serving as an outlet is disposed near the wall surface of the mounting member 17, the injected adhesive can easily reach the wall surface of the mounting member 17. In addition, cross-sectional shapes and cross-sectional areas of a plurality of through holes 37 may be different from one another.

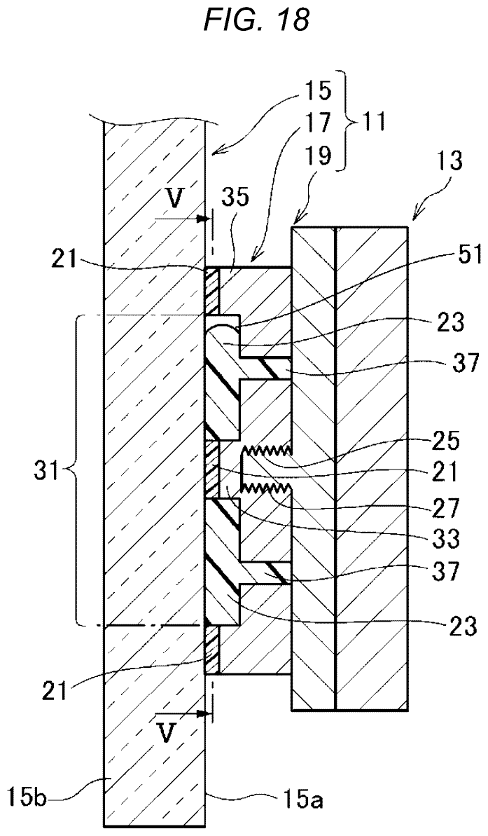

In addition, in the above configuration example and modifications, a case where the space 39 is completely filled with the adhesive to be the second adhesive layer 23 has been described. However, as shown in FIG. 18, the space 39 may not be completely filled with the adhesive, and thereby an air layer 51 may be formed in at least a portion between the wall surface of the mounting member 17 and the second adhesive layer 23. In this case, for example, it is preferable to use a moisture-curing adhesive as the adhesive, since the curing of the adhesive at a portion in contact with the air layer 51 is accelerated and the uncured portion is reduced.

As described above, the following matters are disclosed in the present description.
(1) A glass diaphragm including:
   a glass plate structure;
   a mounting member fixed to the glass plate structure;
   a connection member that is attached to the mounting member and is to be fixed to an exciter for vibrating the glass plate structure; and
   a first adhesive layer and a second adhesive layer, each of the first adhesive layer and the second adhesive layer being disposed between the glass plate structure and the mounting member, in which
   a material of the first adhesive layer is different from a material of the second adhesive layer.

According to the glass diaphragm having this configuration, the glass plate structure and the mounting member to which the connection member fixed to the exciter is attached can be easily fixed to each other with a simple structure by the first adhesive layer and the second adhesive layer disposed between the glass plate structure and the mounting member.

In addition, when the first adhesive layer and the second adhesive layer are made of different materials, and one of them is an adhesive layer having excellent handleability and having good vibration transmissibility, the workability of attaching the mounting member to the glass plate structure can be improved, and the vibration from the exciter can be smoothly transmitted to the glass plate structure, thereby improving the acoustic effect. In addition, when the first adhesive layer and the second adhesive layer are made of different materials and the other of them is an adhesive layer having a high adhesive force, the glass plate structure and the mounting member are firmly fixed to each other, the exciter or a member in which the connection member and the exciter are integrated can be stably attached to the glass plate structure, and a decrease in quality of sound emitted from the glass diaphragm and falling off of the exciter due to displacement of the exciter can be prevented.

(2) The glass diaphragm according to (1), in which the first adhesive layer and the second adhesive layer are in contact with both the glass plate structure and the mounting member.

According to the glass diaphragm having this configuration, the mounting member can be satisfactorily fixed to the glass plate structure by the first adhesive layer and the second adhesive layer which are in contact with both the glass plate structure and the mounting member.

(3) The glass diaphragm according to (1) or (2), in which the first adhesive layer and the second adhesive layer include a portion in contact with from each other.

According to the glass diaphragm having this configuration, since the first adhesive layer and the second adhesive layer include a portion in contact with from each other, a gap between the first adhesive layer and the second adhesive layer is reduced, and an adhesive strength is increased.

(4) The glass diaphragm according to any one of (1) to (3), in which the first adhesive layer includes a portion disposed outside the second adhesive layer based on a center of gravity of the mounting member in a plan view of the glass plate structure.

According to the glass diaphragm having this configuration, the mounting member can be fixed to the glass plate structure in a well-balanced manner by the second adhesive layer and the first adhesive layer disposed outside the second adhesive layer with respect to the center of gravity of the mounting member in the plan view of the glass plate structure.

(5) The glass diaphragm according to (4), in which the first adhesive layer includes a portion disposed outside the mounting member in the plan view of the glass plate structure.

According to the glass diaphragm having this configuration, since the first adhesive layer has a portion disposed outside the mounting member, the mounting member can be sufficiently adhesively fixed to the glass plate structure.

(6) The glass diaphragm according to (4) or (5), in which the first adhesive layer is disposed in a closed loop shape surrounding the second adhesive layer in the plan view of the glass plate structure.

According to the glass diaphragm having this configuration, since the first adhesive layer is disposed in a closed loop shape surrounding the second adhesive layer in the plan view of the glass plate structure, the second adhesive layer can be surrounded and protected by the first adhesive layer, and the durability of the adhesively fixed portion by the second adhesive layer can be improved. In addition, for example, with the mounting member adhering to the glass plate structure by the first adhesive layer, the second adhesive layer can be used for filling and can be disposed inside the first adhesive layer without leaking out.

(7) The glass diaphragm according to any one of (1) to (6), in which the second adhesive layer is thicker than the first adhesive layer.

According to the glass diaphragm having this configuration, the adhesive strength of the mounting member to the glass plate structure can be increased by the second adhesive layer thicker than the first adhesive layer.

(8) The glass diaphragm according to any one of (1) to (7), in which the first adhesive layer is disposed in a central region including the center of gravity of the mounting member in the plan view of the glass plate structure.

According to the glass diaphragm having this configuration, the central region including the center of gravity of the mounting member in the plan view of the glass plate structure can satisfactorily adhere to the glass plate structure by the first adhesive layer.

(9) The glass diaphragm according to any one of (1) to (8), in which the mounting member includes at least one through hole.

According to the glass diaphragm having this configuration, a space between the glass plate structure and the mounting member can be filled with at least one of an adhesive to be the first adhesive layer and an adhesive to be the second adhesive layer through the through hole of the mounting member.

(10) The glass diaphragm according to (9), in which the mounting member includes a plurality of through holes in contact with the second adhesive layer.

According to the glass diaphragm having this configuration, a space between the glass plate structure and the mounting member can be filled with the adhesive to be the second adhesive layer through the through holes of the mounting member. In addition, since the mounting member includes a plurality of through holes, when the adhesive to be the second adhesive layer is used for filling through any one of the through holes, other through holes act as air vent holes, allowing the adhesive to be used for filling smoothly.

(11) The glass diaphragm according to (10), in which at least one of the through holes is formed in a side wall surface of the mounting member different from a surface to which the connection member is attached.

According to the glass diaphragm having this configuration, the through hole in the side wall surface of the mounting member different from the surface to which the connection member is attached can be used as an adhesive outlet. Accordingly, it is possible to prevent the adhesive that leaks out when used for filling the space between the glass plate structure and the mounting member from adhering to the surface of the mounting member that serves as an attachment surface for the connection member. Therefore, it is possible to prevent the adhesive from adhering and forming irregularities on the surface of the mounting member that serves as the attachment surface for the connection member, and to cause the connection member to be attached in close contact with the mounting member. Accordingly, the vibration of the exciter can be transmitted more effectively to the glass plate structure via the mounting member.

(12) The glass diaphragm according to any one of (9) to (11), in which the through hole extends in a thickness direction of the glass plate structure.

According to the glass diaphragm having this configuration, the adhesive can be used for filling smoothly through the through hole extending in the thickness direction of the glass plate structure in the mounting member.

(13) The glass diaphragm according to any one of (9) to (12), in which the through hole has a width smaller than a width of the second adhesive layer.

According to the glass diaphragm having this configuration, the adhesive to be the second adhesive layer can be used for filling smoothly through the through hole, which has a width smaller than the width of the second adhesive layer.

(14) The glass diaphragm according to any one of (9) to (13), in which the second adhesive layer includes a plurality of layers in contact with the glass plate structure and spaced apart from each other, and a portion for connecting the plurality of layers and for filling a connection groove.

According to the glass diaphragm having this configuration, the mounting member can be adhesively fixed to the glass plate structure by the second adhesive layer having a plurality of layers.

(15) The glass diaphragm according to any one of (1) to (14), in which the second adhesive layer has a Young's modulus of 1×10⁵ [Pa] or more.

According to the glass diaphragm having this configuration, since the second adhesive layer has a Young's modulus of 1×10⁵ [Pa] or more, the acoustic vibration from the exciter can be satisfactorily transmitted via the mounting member.

(16) The glass diaphragm according to any one of (1) to (15), in which when a surface area of the first adhesive layer in contact with the glass plate structure is S1, and a surface area of the second adhesive layer in contact with the glass plate structure is S2, S1:S2 satisfies a range of 1:0.01 to 1:100.

According to the glass diaphragm having this configuration, the surface areas of the first adhesive layer and the second adhesive layer in contact with the glass plate structure can be set to have an appropriate ratio, and the mounting member can satisfactorily adhere to the glass plate structure by the first adhesive layer and the second adhesive layer.

(17) The glass diaphragm according to any one of (1) to (16), in which the mounting member has an area on a glass plate structure side larger than an area on a side away from the glass plate structure in the plan view of the glass plate structure.

According to the glass diaphragm having this configuration, an area of the mounting member on a side fixed to the glass plate structure can be increased, and the adhesive strength of the mounting member to the glass plate structure by the first adhesive layer and the second adhesive layer can be increased.

(18) The glass diaphragm according to (17), in which the mounting member includes a step toward the glass plate structure.

According to the glass diaphragm having this configuration, when the mounting member has a step toward the glass plate structure, an area of the mounting member on a side fixed to the glass plate structure can be easily increased, and an adhesive strength of the mounting member to the glass plate structure by the first adhesive layer and the second adhesive layer can be increased.

(19) The glass diaphragm according to any one of (1) to (18), in which the mounting member is fixed only to a first main surface of the glass plate structure.

According to the glass diaphragm having this configuration, since the connection member is attached to the mounting member fixed to the first main surface of the glass plate structure, the exciter can be stably attached to the glass plate structure.

(20) The glass diaphragm according to any one of (1) to (18), in which the mounting member is fixed to a first main surface and a second main surface of the glass plate structure.

According to the glass diaphragm having this configuration, since the connection member is attached to the mounting member fixed to the first main surface and the second main surface of the glass plate structure, the exciter can be more stably attached to the glass plate structure.

(21) The glass diaphragm according to (20), in which the mounting member faces an end surface connecting the first main surface and the second main surface of the glass plate structure.

According to the glass diaphragm having this configuration, since the mounting member fixed to the first main surface and the second main surface of the glass plate structure faces the end surface connecting the first main surface and the second main surface, the mounting member can also be adhesively fixed to a portion facing this end surface. Accordingly, a fixing strength of the mounting member to the glass plate structure can be further increased, and the exciter can be more stably attached to the glass plate structure.

(22) The glass diaphragm according to (21), in which the second adhesive layer is in contact with the first main surface, the second main surface, and the end surface of the glass plate structure.

According to the glass diaphragm having this configuration, the portion of the mounting member that faces the end surface of the glass plate structure can be adhesively fixed to the end surface by the second adhesive layer. Accordingly, the fixing strength of the mounting member to the glass plate structure is further increased, and the exciter can be more stably attached to the glass plate structure.

(23) The glass diaphragm according to any one of (20) to (22), in which the glass plate structure includes a through hole, and the mounting member includes a portion penetrating the through hole and is fixed to the first main surface and the second main surface.

According to the glass diaphragm having this configuration, since the mounting member has a portion penetrating the through hole of the glass plate structure, falling off of the mounting member from the glass plate structure can be prevented, and the exciter can be stably attached to the glass plate structure.

(24) The glass diaphragm according to (23), in which the second adhesive layer is disposed in at least a portion of the through hole.

According to the glass diaphragm having this configuration, the portion of the mounting member that is disposed in at least a portion of the through hole of the glass plate structure can be adhesively fixed to the glass plate structure by the second adhesive layer. Accordingly, the fixing strength of the mounting member to the glass plate structure is further increased, and the exciter can be more stably attached to the glass plate structure.

(25) The glass diaphragm according to (1), in which an air layer is formed in at least a portion between the mounting member and the second adhesive layer.

According to the glass diaphragm having this configuration, for example, when a moisture-curing adhesive is used as the adhesive, the curing of the adhesive at a portion in contact with the air layer is accelerated and the uncured portion is reduced.

(26) An exciter-attached glass diaphragm including: the glass diaphragm according to any one of (1) to (25); and the exciter.

According to the exciter-attached glass diaphragm having this configuration, the connection member is fixed to the mounting member fixed to the glass plate structure, and accordingly, the glass diaphragm can be made into an exciter-attached glass diaphragm including an exciter.

(27) A method for producing a glass diaphragm, including:
in a mounting member that is fixed to a glass plate structure and to which a connection member of an exciter for vibrating the glass plate structure is to be attached, disposing a first adhesive layer on a surface facing the glass plate structure;
adhering the glass plate structure to the mounting member via the first adhesive layer; and
injecting an adhesive to be a second adhesive layer through an inlet connected to a space provided inside the mounting member, to adhere the glass plate structure to the mounting member via the second adhesive layer.

According to the method for producing a glass diaphragm having this configuration, the glass plate structure and the mounting member adhere to each other via the first adhesive layer disposed on the surface of the mounting member facing the glass plate structure, and accordingly, the mounting member can be easily positioned and fixed to the glass plate structure. Thereafter, the adhesive to be the second adhesive layer is injected through the inlet connected to the space provided inside the mounting member, and accordingly, the glass plate structure and the mounting member can be fixed to each other via the second adhesive layer made of this adhesive. Accordingly, it is possible to produce a glass diaphragm in which the mounting member is firmly fixed to the glass plate structure by the first adhesive layer and the second adhesive layer and the exciter can be stably attached to the glass plate structure.

(28) The method for producing a glass diaphragm according to (27), in which when injecting the adhesive to be the second adhesive layer, the second adhesive layer is visually observed at an outlet connected to the space of the mounting member.

According to the method for producing a glass diaphragm having this configuration, since the second adhesive layer is visually observed at the outlet, a state of the adhesive for filling the space in the mounting member can be easily seen.

(29) A method for producing an exciter-attached glass diaphragm, including: performing the method for producing a glass diaphragm according to (27) or (28); and then attaching the exciter to the mounting member.

According to the method for producing a glass diaphragm having this configuration, it is possible to produce an exciter-attached glass diaphragm in which the exciter is stably attached and in which a decrease in quality of sound emitted from the glass diaphragm and falling off of the exciter due to displacement of the exciter can be prevented.

Note that, the present application is based on a Japanese Patent Application (No. 2022-082515) filed on May 19, 2022, contents of which are incorporated herein by reference.

### REFERENCE SIGNS LIST

11: glass diaphragm
13: exciter
15: glass plate structure
15a: first main surface
15b: second main surface
15c: end surface
15d: through hole
17: mounting member
19: connection member
21: first adhesive layer
23: second adhesive layer
23a: layer
23L: adhesive
37: through hole
39: space
45a: step
100: exciter-attached glass diaphragm
G: center of gravity

1. A glass diaphragm comprising:
a glass plate structure;
a mounting member fixed to the glass plate structure;
a connection member that is attached to the mounting member and is to be fixed to an exciter for vibrating the glass plate structure; and
a first adhesive layer and a second adhesive layer, each of the first adhesive layer and the second adhesive layer being disposed between the glass plate structure and the mounting member, wherein
a material of the first adhesive layer is different from a material of the second adhesive layer.

2. The glass diaphragm according to claim 1, wherein the first adhesive layer and the second adhesive layer are in contact with both the glass plate structure and the mounting member.

3. The glass diaphragm according to claim 1, wherein the first adhesive layer and the second adhesive layer comprise a portion in contact with each other.

4. The glass diaphragm according to claim 1, wherein the second adhesive layer is thicker than the first adhesive layer.

5. The glass diaphragm according to claim 1, wherein the first adhesive layer is disposed in a central region comprising a center of gravity of the mounting member in a plan view of the glass plate structure.

6. The glass diaphragm according to claim 1, wherein the mounting member comprises at least one through hole.

7. The glass diaphragm according to claim 6, wherein the mounting member comprises a plurality of through holes in contact with the second adhesive layer.

8. The glass diaphragm according to claim 7, wherein at least one of the through holes is formed in a side wall surface of the mounting member different from a surface to which the connection member is attached.

9. The glass diaphragm according to claim 6, wherein the through hole extends in a thickness direction of the glass plate structure.

10. The glass diaphragm according to claim 6, wherein the through hole has a width smaller than a width of the second adhesive layer.

11. The glass diaphragm according to claim 6, wherein the second adhesive layer comprises a plurality of layers in contact with the glass plate structure and spaced apart from each other, and a portion for connecting the plurality of layers and for filling a connection groove.

12. The glass diaphragm according to claim 1, wherein the mounting member has an area on a glass plate structure side larger than an area on a side away from the glass plate structure in a plan view of the glass plate structure.

13. The glass diaphragm according to claim 12, wherein the mounting member comprises a step toward the glass plate structure.

14. The glass diaphragm according to claim 1, wherein the mounting member is fixed to a first main surface and a second main surface of the glass plate structure.

15. The glass diaphragm according to claim 14, wherein the glass plate structure comprises a through hole, and
the mounting member comprises a portion penetrating the through hole and is fixed to the first main surface and the second main surface.

16. The glass diaphragm according to claim 15, wherein the second adhesive layer is disposed in at least a portion of the through hole.

17. The glass diaphragm according to claim 1, wherein an air layer is formed in at least a portion between the mounting member and the second adhesive layer.

18. A method for producing a glass diaphragm, comprising:
in a mounting member that is fixed to a glass plate structure and to which a connection member of an exciter for vibrating the glass plate structure is to be attached, disposing a first adhesive layer on a surface facing the glass plate structure;
adhering the glass plate structure to the mounting member via the first adhesive layer; and
injecting an adhesive to be a second adhesive layer through an inlet connected to a space provided inside the mounting member, to adhere the glass plate structure to the mounting member via the second adhesive layer.

19. The method for producing a glass diaphragm according to claim 18, wherein when injecting the adhesive to be the second adhesive layer, the second adhesive layer is visually observed at an outlet connected to the space of the mounting member.

20. A method for producing an exciter-attached glass diaphragm, comprising:
performing the method for producing a glass diaphragm according to claim 18; and then attaching the exciter to an mounting member.
